(19) United States
(12) Patent Application Publication
(10) Pub. No.: US 2025/0390830 A1
(43) Pub. Date: Dec. 25, 2025

(54) BATCHING SYSTEM FOR EFFICIENT DELIVERY MANAGEMENT

(71) Applicant: CFA Properties, Inc., Atlanta, GA (US)

(72) Inventors: Brian Moore, Atlanta, GA (US); Ben Haverly, Atlanta, GA (US); Luke Schmidt, Atlanta, GA (US); Lloyd Engebretsen, Atlanta, GA (US); Mark Peppers, Atlanta, GA (US)

(21) Appl. No.: 19/249,075

(22) Filed: Jun. 25, 2025

Related U.S. Application Data
(60) Provisional application No. 63/663,885, filed on Jun. 25, 2024.

(51) Int. Cl. G06Q 10/083; G06Q 10/0631; G06Q 10/087

(52) U.S. Cl. CPC G06Q 10/083; G06Q 10/06311; G06Q 10/08741

(57) ABSTRACT

Embodiments of the present disclosure relate to a system and method for order batching. An example method includes receiving a plurality of orders for delivery to a plurality of destinations; generating permutations of the orders corresponding to different sequences of the destinations; estimating, for the permutations, one or more of a total delivery time, a total promise time miss, and a total hold time miss; generating batch scores for the permutations based on the respective total delivery time, total promise time miss, and total hold time miss; generating a permutation ranking based on the batch scores; determining a top-ranked permutation; assigning orders in the top-ranked permutation to one of a plurality of delivery persons; initiating preparation of the orders in response to determining that an estimated arrival interval of the delivery person is within an estimated preparation interval; and dispatching delivery of the orders to the delivery person.

### CROSS REFERENCE TO RELATED APPLICATIONS

This application claims the benefit of and priority to U.S. Application No. 63/663,885, filed Jun. 25, 2024, entitled “BATCHING SYSTEM FOR EFFICIENT DELIVERY MANAGEMENT,” the disclosure of which is incorporated herein by reference in its entirety.

### TECHNICAL FIELD

This application generally relates to systems and processes for improving delivery order batching and efficiency.

### BACKGROUND

In quick-service restaurants (QSR), delivery orders are commonly fulfilled by third-party services that facilitate order intake and conduct delivery. For example, services such as DoorDash connect local consumers and local restaurants with delivery made possible by independent contractors. The third-party services are responsible for recruiting and managing the independent delivery persons and, thus, are capable of dynamically increasing staffing as needed to meet the demands of the restaurants. Conversely, QSR operators may desire to conduct delivery operations using their own employees to minimize costs and preserve quality control over customer experiences. However, unlike third-party delivery services, QSRs are typically unable to scale their workforces dynamically to meet demand. Thus, QSRs and DCs have not yet solved the challenges of efficiently fulfilling orders within the constraints of a finite workforce.

### BRIEF SUMMARY

Embodiments of the present disclosure relate to systems, methods, and computer program products for delivery management. For example, according to a first aspect of the present disclosure, there is provided a method for delivery management comprising receiving a plurality of orders for delivery to a plurality of destinations; generating a plurality of permutations of the plurality of orders corresponding to different sequences of the plurality of destinations; estimating, for the plurality of permutations, one or more of a total delivery time, a total promise time miss, and a total hold time miss; generating, for the plurality of permutations, a batch score based on the one or more of the total delivery time, the total promise time miss, and the total hold time miss; generating a ranking of at least a portion of the plurality of permutations based on the respective batch scores; determining a top-ranked permutation based on the ranking; assigning orders in the top-ranked permutation to one of a plurality of delivery persons for fulfillment; initiating preparation of the orders in the top-ranked permutation in response to determining that an estimated arrival interval of the one of the plurality of delivery persons is within an estimated preparation interval for the orders in the top-ranked permutation; and dispatching delivery of the orders in the top-ranked permutation to the one of the plurality of delivery persons.

In some embodiments, the method further comprises obtaining deliverer data associated with the plurality of delivery persons; and generating the batch score based at least in part on the deliverer data. In some embodiments, the deliverer data comprises a respective current location of the plurality of delivery persons. In some embodiments, the deliverer data comprises a respective transportation mode of the plurality of delivery persons. In some embodiments, the deliverer data comprises, for the plurality of delivery persons, at least one historical delivery metric associated with the respective delivery person. In some embodiments, the at least one historical delivery metric comprises at least one of an average order completion time, a historical timeliness metric, a historical efficiency metric. In some embodiments, the deliverer data comprises a respective current workload of the plurality of delivery persons. In some embodiments, the deliverer data comprises a respective availability status of the plurality of delivery persons. In some embodiments, the deliverer data comprises an estimated QSR return time for the plurality of delivery persons. In some embodiments, the deliverer data comprises a respective carrying capacity of the plurality of delivery persons.

In some embodiments, a respective permutation is associated with one of a plurality of delivery persons. In some embodiments, a respective order comprises at least one food item. In some embodiments, the method further comprises determining at least one of a plurality of temperature classifications associated with the at least one food item; and/or determining one of a plurality of container types associated with the delivery person; and generating the total hold time miss based at least in part on the temperature classification and/or the container type. In some embodiments, the plurality of container types comprise paper container, passive insulated container, or active climate-controlled delivery container. In some embodiments, the plurality of temperature classifications comprise hot, ambient, cold, and frozen.

In some embodiments, the method further comprises generating, for the plurality of delivery persons, at least one dynamic driver metric based on real-time delivery data; and updating the batch score based on the at least one dynamic driver metric. In some embodiments, the method further comprises applying a first weight value to the total delivery time; and/or applying a second weight value to the total promise time miss; and/or applying a third weight value to the total hold time miss; and/or generating the batch score based on the weighted total delivery time, the weighted total promise time miss, and/or the weighted total hold time miss. In some embodiments, the method further comprises receiving, via a user interface, an adjustment to at least one of the first weight value, the second weight value, or the third weight value; applying the adjustment to the at least one of the first weight value, the second weight value, or the third weight value; and generating updated batch scores for subsequent permutations based on the adjusted weight values. In some embodiments, the method further comprises generating the third weight value based at least in part on a temperature classification of the at least one food item of the plurality of orders.

In some embodiments, the method further comprises receiving an additional order after preparation of the orders in the top-ranked permutation has occurred; in response to determining that a proximity of a destination of the additional order is within a threshold range to a destination of at least one of the orders in the top-ranked permutation, updating the top-ranked permutation to comprise the additional order; and initiating preparation of the additional order.

According to an aspect of the present disclosure, there is provided an apparatus configured to perform one or more operations and/or embody additional aspects of the above-described methods. For example, an apparatus may include at least one processor and at least one memory storing instructions that, when executed by the at least one processor, cause the apparatus to perform at least: receiving a plurality of orders for delivery to a plurality of destinations; generating a plurality of permutations of the plurality of orders corresponding to different sequences of the plurality of destinations; estimating, for the plurality of permutations, one or more of a total delivery time, a total promise time miss, and a total hold time miss; generating, for the plurality of permutations, a batch score based on the one or more of the total delivery time, the total promise time miss, and the total hold time miss; generating a ranking of at least a portion of the plurality of permutations based on the respective batch scores; determining a top-ranked permutation based on the ranking; assigning orders in the top-ranked permutation to one of a plurality of delivery persons for fulfillment; initiating preparation of the orders in the top-ranked permutation in response to determining that an estimated arrival interval of the one of the plurality of delivery persons is within an estimated preparation interval for the orders in the top-ranked permutation; and dispatching delivery of the orders in the top-ranked permutation to the one of the plurality of delivery persons. In the same example, the apparatus may also be configured to perform additional operations and/or embody additional aspects of the above-described methods.

According to another aspect of the present disclosure, there is provided a computer program product, including at least one non-transitory computer-readable storage medium having computer-executable program code portions stored therein with the computer-executable program code portions including program code instructions configured for performing one or more operations and/or embody additional aspects of the above-described methods. For example, a computer program product may include at least one non-transitory computer-readable storage medium having computer-executable program code instructions stored therein, the computer-executable program code instructions including program code instructions configured to: receive a plurality of orders for delivery to a plurality of destinations; generate a plurality of permutations of the plurality of orders corresponding to different sequences of the plurality of destinations; estimate, for the plurality of permutations, one or more of a total delivery time, a total promise time miss, and a total hold time miss; generate, for the plurality of permutations, a batch score based on the one or more of the total delivery time, the total promise time miss, and the total hold time miss; generate a ranking of at least a portion of the plurality of permutations based on the respective batch scores; determine a top-ranked permutation based on the ranking; assign orders in the top-ranked permutation to one of a plurality of delivery persons for fulfillment; initiate preparation of the orders in the top-ranked permutation in response to a determination that an estimated arrival interval of the one of the plurality of delivery persons is within an estimated preparation interval for the orders in the top-ranked permutation; and dispatch delivery of the orders in the top-ranked permutation to the one of the plurality of delivery persons. In the same example, the program code instructions may also be configured to perform additional operations and/or embody additional aspects of the above-described methods.

The foregoing general description of the illustrative embodiments and the following detailed description thereof are merely exemplary aspects of the teachings of this disclosure and are not restrictive.

### BRIEF DESCRIPTION OF THE FIGURES

Having thus described the embodiments of the disclosure in general terms, reference now will be made to the accompanying drawings, which are not necessarily drawn to scale, and wherein:

FIG. 1 shows an example diagram of an order batching technique in accordance with typical approaches;

FIG. 2 shows an example diagram of an order batching technique in accordance with typical approaches;

FIG. 3 shows an example batching system in accordance with some embodiments of the present disclosure;

FIG. 4 shows an example diagram of an order batching approach in accordance with some embodiments of the present disclosure; and

FIG. 5 shows an example computing device having rendered thereon a delivery availability interface in accordance with some embodiments of the disclosure;

FIG. 6 shows an example computing device having rendered thereon a batched delivery assignment interface in accordance with some embodiments of the disclosure;

FIG. 7 shows an example computing device having rendered thereon an order information interface in accordance with some embodiments of the disclosure;

FIG. 8 shows an example computing device having rendered thereon an order information interface in accordance with some embodiments of the disclosure;

FIG. 9 shows an example computing device having rendered thereon an order information interface in accordance with some embodiments of the disclosure;

FIG. 10 shows an example computing device having rendered thereon a delivery confirmation interface in accordance with some embodiments of the disclosure;

FIG. 11 shows an example computing device having rendered thereon a delivery management network interface in accordance with some embodiments of the disclosure;

FIG. 12 shows an example computing device having rendered thereon a comprehensive delivery management interface in accordance with some embodiments of the disclosure;

FIG. 13 shows an example computing device having rendered thereon an integrated delivery management system interface in accordance with some embodiments of the disclosure;

FIG. 14 shows an example computing device having rendered thereon an order history interface in accordance with some embodiments of the disclosure;

FIG. 15 shows an example computing device having rendered thereon an activity log interface in accordance with some embodiments of the disclosure;

FIG. 16 shows an example computing device having rendered thereon a delivery management system interface in accordance with some embodiments of the disclosure;

FIG. 17 shows an example computing device having rendered thereon a delivery management system interface in accordance with some embodiments of the disclosure; and

FIG. 18 shows an example computing device having rendered thereon a delivery management system interface in accordance with some embodiments of the disclosure.

### DESCRIPTION

In general, various embodiments of the present disclosure provide improved systems for efficiently managing delivery orders. Specifically, various embodiments of the present disclosure provide techniques for generating batches of orders to optimize delivery efficiency and better meet customer satisfaction and food quality targets. For purposes of describing and illustrating exemplary aspects of the batching system, the proceeding description is presented in the context of delivering food products from QSRs. It will be understood and appreciated that such context is provided by way of example and uses of the system in additional contexts, such as with other perishable products having limited delivery windows, are contemplated and within the scope of the invention.

Increasing delivery person workloads (e.g., a quantity of orders assigned to a deliverer) tends to increase delivery person efficiency and improve restaurant throughput. However, typical approaches to organizing order fulfillment demonstrate drawbacks when implemented in the context of restaurants having finite delivery resources. For example, third-party service-based delivery solutions may dynamically and continuously scale the number of partnered delivery persons based on restaurants' demands, thereby reducing inefficiencies introduced by increased delivery volume and complexity. Conversely, QSRs seeking to conduct delivery by an in-house delivery person are incapable of ad hoc adjustments to their workforces and, as a result, face a greater need to efficiently schedule and distribute orders in a resource efficient manner. Other approaches to organizing order delivery may assign orders to delivery persons based on principles of equal distribution and workload maximization. However, such techniques may ignore factors specific to delivery persons and delivery patterns, potentially resulting in excessive hold times and missed promise times. For example, a QSR may have four delivery persons and assign each delivery person the maximum workload of ten deliveries. As a result, order throughput may be maximized; however, exceedances in order promise times and order hold times may significantly reduce food quality upon delivery and, thereby, customer satisfaction.

In various embodiments, the present disclosure provides an improved batching system that optimizes delivery efficiency and prioritizes compliance with order promise and hold times. The disclosed batching system may generate optimized batches based at least in part by generating and scoring all possible permutations of batch composition for an input set of orders and existing unassigned batches based on respective driver efficiency, promise times, and hold times. For example, the batching system may generate a respective batch score for each of a plurality of batch permutations based at least in part on a weighted combination of total delivery time, total promise time miss, and total hold time miss derived from a computationally simulated delivery of the batched orders. In some embodiments, the batching system is configured to prioritize (e.g., more heavily weight) scheduled orders having explicit delivery times as compared to orders associated with an as soon as possible (ASAP) delivery expectation.

### Typical Batching Approaches

A challenge of order delivery management includes determining a quantity of orders that may be assigned to a delivery person at one time. For example, a delivery person with a lower workload (e.g., batch size) may demonstrate faster delivery times for an assigned batch of orders, which may increase satisfaction of the associated customers. However, in such instances, other order completions may be delayed and the QSR may experience resource inefficiency due to an overall reduced throughput. As another example, a delivery person with a greater assigned batch size may increase the throughput of the QSR; however, order completion time for a subset of the orders may increase significantly, which may adversely impact food quality and customer satisfaction.

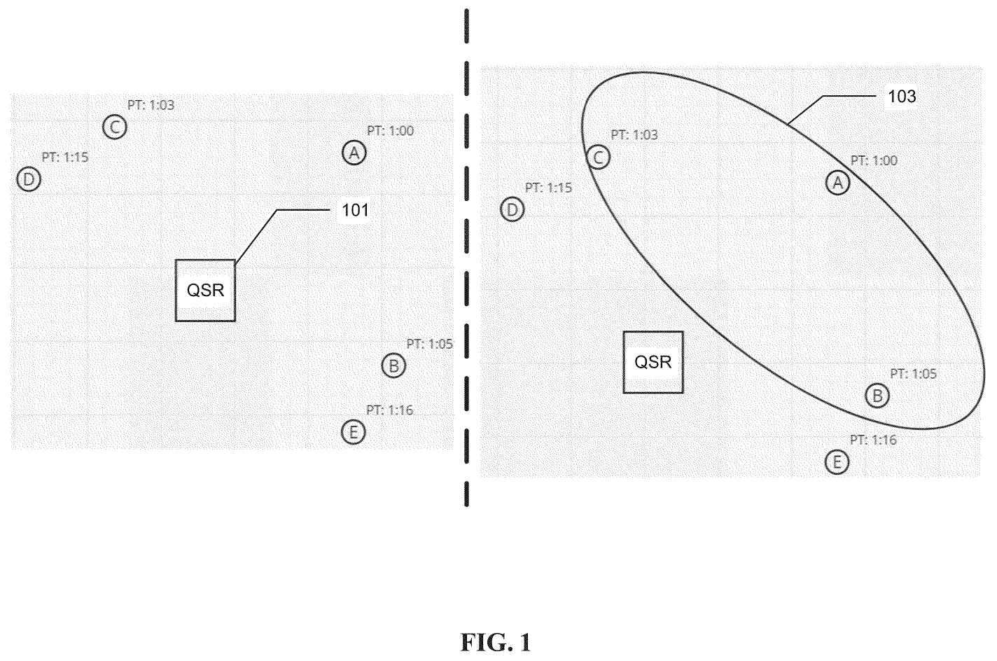

FIG. 1. shows a diagram of an example technique for batching orders according to typical approaches. A QSR 101 may receive orders A, B, C, D, and E and provide to the associated customers a promised delivery time (“PT”) of 1:00, 1:05, 1:03, 1:15, and 1:16, respectively. A typical batching approach may prioritize the close proximity of destinations for orders A, B, C and generate a batch 103 comprising orders A, B, C. However, batch 103 excludes orders D and E, which are located in relatively opposing directions from the QSR 101 and demonstrate similar PT (e.g., 1:15 and 1:16, respectively). As a result, two additional drivers may be required to deliver orders D and E within their assigned PT, which may significantly reduce delivery person and restaurant efficiency.

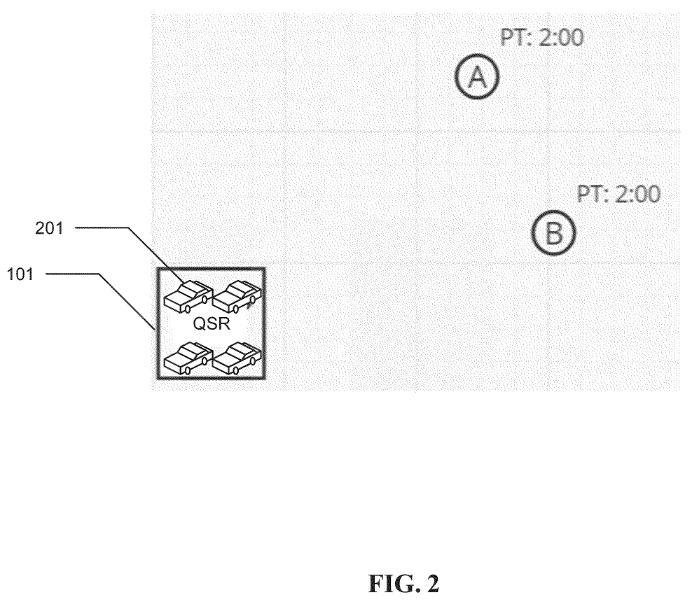

As another example, as shown in FIG. 2, a QSR 101 may receive at time 1:55 orders A and B, where each order is assigned a PT of 2:00. A typical approach to batching may group orders A and B into a batch 201 for a single delivery person based on the close proximity of the corresponding destinations. However, such approaches fail to factor the impossibility of the delivery person to meet the PT for two orders simultaneously. As a result, at least one of orders A and B will be delivered late, which may reduce customer satisfaction and/or food quality.

To overcome these challenges, and others, the present batching system accounts for a greater quantity and complexity of factors to optimize order grouping and assignment. In doing so, the batching system may improve restaurant and delivery person efficiency, increase customer satisfaction, and ensure delivery of food items within sufficient timeframes to preserve food quality.

### Example Batching System

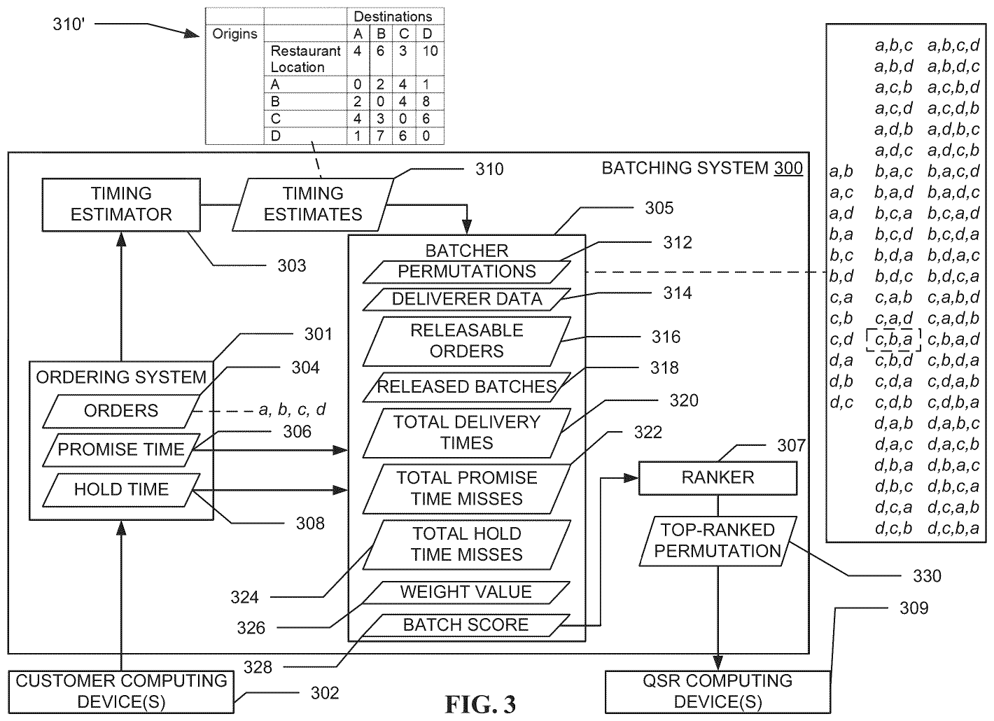

FIG. 3 shows an example batching system 300. In various embodiments, the batching system 300 is configured to generate batches of orders for distribution by respective delivery persons. In some embodiments, the batching system 300 is configured to generate all permutations of unbatched orders and batched orders that have not departed the QSR and/or have not been assigned to a delivery person. In some embodiments, the batching system 300 is configured to generate permutations based on a maximum batch size. For example, the batching system 300 may generate all permutations of three or fewer orders (or another suitable value). In some embodiments, the batching system 300 is configured to generate a batch score for each permutation and determine a top-ranked batch based at least in part on the batch scores. In various embodiments, the batching system 300 factors releasable orders, released batches, and deliverer data into batch generation and scoring. For example, the batching system 300 may generate a batch score based at least in part on deliverer data (e.g., delivery person quantity and current delivery person locations), order promise times, order hold times, and/or the like. A batch score may simulate delivery of the permutation of orders in the batch. The batch score may be generated based at least in part on values of total delivery time, total promise time miss, and total hold time miss. Further, in some embodiments, respective weight values may be applied to the values of total delivery time, total promise time miss, and total hold time miss to influence the level of contribution of the corresponding metric to the batch score. In doing so, the batching system 300 may generate optimal batches of orders within the full context of the restaurant workload, delivery person locations, food quality targets, and customer expectations.

A delivery person may refer to any entity that transports an order from a QSR to a destination, such as a customer domicile. A delivery person may embody a human, computing entity, autonomous vehicle and/or the like. A delivery person may utilize any form of transportation including ambulation, public transportation, vehicle-based movement, and/or the like. An order may include any number of items, including food and non-food items. An order may be associated with a destination, such as a location of a customer or other location indicated by a customer during submission of the order.

In various embodiments, the batching system 300 includes an ordering system 301, timing estimator 303, batcher 305, and ranker 307. Alternatively, in some embodiments, the timing estimator 303 comprises an external computing environment that is remote from the batching system 300, such as software-as-a-service provider. For example, the timing estimator 303 may embody a remote web server, platform, and/or the like with which the batching system 300 is configured to communicate. One example is the Distance Matrix API available from Google. In various embodiments, the batching system 300 is configured to communicate with customer computing devices 302, QSR computing devices 309, computing devices of delivery persons, and/or the like. In some embodiments, the ordering system 301 is configured to receive orders 304 from the customer computing devices 302. For example, a customer computing device 302 may have installed thereon an application by which a selection of food items may be provisioned to the ordering system 301.

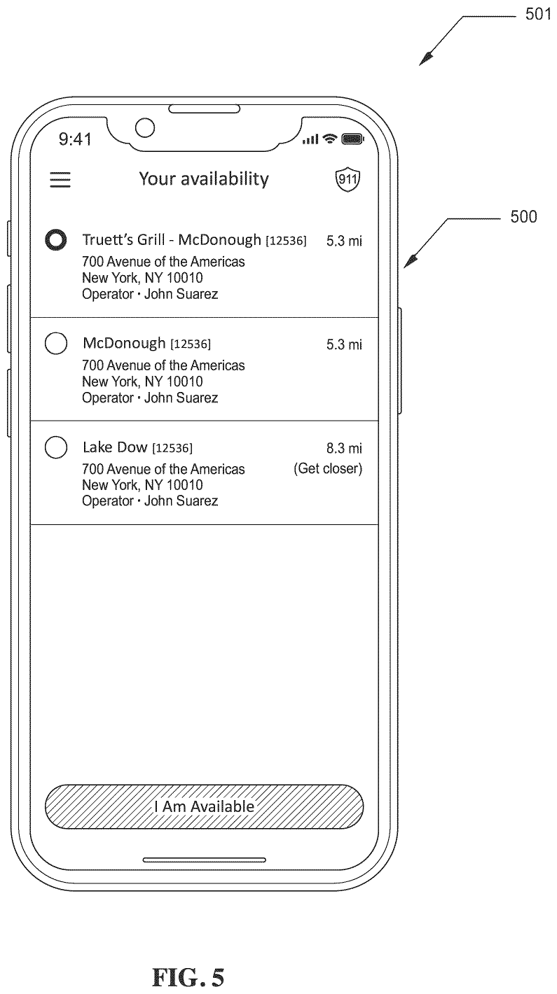

In some embodiments, a QSR computing device 309 is configured to indicate batch composition and assignment to a delivery person. For example, a QSR computing device 309 may be carried by a team member and configured to receive and render assigned batches assigned to the delivery person. As another example, a QSR computing device 309 may be located within a QSR. In various embodiments, the computing device of the delivery person is configured to receive data from and provide data to the QSR computing device 309, the batching system 300, and/or the like. For example, a QSR computing device 309 may embody one or more tablets, desktops, smartphones, and/or the like, installed within a QSR and a second computing device may embody a smartphone, tablet, and/or the like that is carried by a delivery person and in communication with the QSR computing device 309. The QSR computing device 309, computing device of the delivery person, and/or the like, may comprise one or more applications, programs, and/or the like by which the delivery person may interface with the batching system 300 and QSR computing devices 309. For example, as shown in FIGS. 5-18, a computing device (e.g., computing device of a delivery person or QSR computing device 309) may enable the delivery person or QSR team member to receive order assignments and communicate information related to order delivery and fulfillment.

In some embodiments, the ordering system 301 is configured to generate a promise time 306 for an order 304. For example, the ordering system 301 may receive orders a, b, c, and d and generate a respective promise time 306 for each order. In various embodiments, a promise time 306 is a time value or range at which delivery of the corresponding order to a customer is promised. In some embodiments, the ordering system 301 is configured to generate a hold time 308 for an order 304. In various embodiments, a hold time 308 is a time value or range associated with optimal or acceptable quality for one or more food items. For example, a hold time 308 for chicken tenders may define a maximum time following tender preparation at which the chicken tenders are considered to be at optimal levels of temperature, freshness, texture, taste, and/or the like. In various embodiments, different food items may be associated with different hold times 308. For example, a milkshake may be associated with a lower hold time 308 as compared to a hold time 308 with which a sandwich is associated. In some embodiments, in instances where an order 304 includes different food items, the ordering system 301 is configured to assign to the order 304 an overall hold time 308 based on the food item with the lowest individual hold time. For example, an order 304 may include a sandwich having a hold time of 30 minutes and a milkshake having a hold time of 20 minutes. In such context, the ordering system 301 may generate for the order 304 an overall hold time 308 based of 20 minutes.

In some embodiments, the ordering system 301 generates a hold time 308 based at least in part on a container type within which food items of an order may be carried. In some embodiments, container types include paper container, passive insulated container, active climate-controlled delivery container, and/or the like. The ordering system 301 may generate a greater hold time 308 (or buffer an existing hold time 308) for a food item based on the container type. For example, an order of waffle fries may be associated with a hold time 308 of 10 minutes when transported in a paper container. The ordering system 301 may extend the hold time 308 in instances in which the waffle fries are transported in a climate-controlled container, such as one or more embodiments of a food transportation system provided in U.S. Pat. No. 11,918,153, which is hereby incorporated by reference.

In various embodiments, the timing estimator 303 is configured to generate timing estimates 310 indicative of travel time between two or more locations. In various embodiments, a timing estimate 310 embodies a distance matrix representative of time required to travel between destinations. For example, the timing estimate 310′ may embody a distance matrix indicative of an estimated time required to travel between each of the destinations of orders a, b, c, and d and the location of the QSR.

In some embodiments, the ordering system 301 is configured to provision to the timing estimator 303 a location of the QSR and locations of the respective destinations of a plurality of orders 304. For example, at a predetermined interval (e.g., 90 seconds, 10 minutes, 15 minutes, or another suitable value) the ordering system 301 may provision to the timing estimator 303 the destinations of all unbatched orders 304 stored at the ordering system 301 and all batched orders 304 that have not departed the QSR. The timing estimator 303 may generate a timing estimate 310 (e.g., distance matrix) indicative of the time required to travel between each provisioned destination and between each provisioned destination and the location of the QSR. In some embodiments, the ordering system 301 provisions to the timing estimator 303 a transportation mode to cause the timing estimator 303 to generate the timing estimate 310 based at least in part on the manner of movement of a delivery person. For example, the transportation mode may include automobile, bicycle, electric scooter, ambulation, public transit, and/or the like.

Additionally, or alternatively, in some embodiments, the ordering system 301 is configured to group orders 304 into a plurality of sectors based at least in part on the respective destinations of the orders 304, current location of one or more delivery persons, location of the QSR, and/or the like. For example, the ordering system 301 may process a plurality of orders 304 and associated destinations to generate subset of orders (e.g., “order sectors”) located within a threshold distance of one another. In some embodiments, the ordering system 301 determines a respective centroid (or a nearest boundary relative to the delivery person or QSR) of each order sector. In some embodiments, the ordering system 301 provisions to the timing estimator 303 the respective locations of the order sectors (e.g., represented as a centroid, nearest boundary, and/or the like) to cause the timing estimator 303 to generate timing estimates 310 for traveling from the QSR to the order sector. The batcher 305 may utilize the timing estimates 310, and potentially other data (e.g., driver efficiency, estimated promise time miss, estimated hold time miss, and/or the like) to score the order sectors for fulfillment. Additionally, or alternatively, the batching system 300 may score a plurality of delivery persons on their estimated ability to fulfill orders in an order sector based at least in part on the timing estimates 310 and current location of the delivery person. In some embodiments, the batching system 300 may iteratively regenerate and rescore order sectors to identify an optimal sector permutation respective to meeting promise times, hold times, and/or the like.

In various embodiments, the batcher 305 is configured to generate and score permutations 312 representing possible batches of orders 304. A respective permutation 312 may embody a course of travel for delivering one or more orders. In some embodiments, the batcher 305 is configured to receive orders 304, promise times 306, hold times 308, and/or the like from the ordering system 301. For example, the batcher 305 may receive from the ordering system 301 orders a, b, c, and d and the promise times 306 and hold times 308 associated with the orders. In some embodiments, the batcher 305 generates a plurality of permutations 312 based at least in part on the orders 304. For example, the batcher 305 may generate permutations 312 representing every possible combination of orders a, b, c, and d, and subsets thereof. In some embodiments, the orders factored into permutation generation further include orders from unreleased batches still located at the QSR. For example, the batcher 305 may generate permutations 312 further based at least in part on unreleased batches of orders that have not been assigned to a delivery person and/or are prepared but have not been picked up by an assigned delivery person. In some embodiments, the batcher 305 is configured to generate permutations 312 based on a maximum batch size. An example maximum batch size may be 3, 4, or 5 orders (or another suitable value), and may correspond to a maximum carrying capacity or workload of a delivery person. In some embodiments, the batcher 305 increases or decreases the maximum batch size based at least in part on the total workload of the QSR, transportation modes of available delivery persons, availability of carrying containers, and/or the like.

In some embodiments, the batcher 305 is configured to sequence orders within a permutation 312 based at least in part on temperature classifications associated with the orders. In various embodiments, the temperature classifications include hot (e.g., food item is preferably served at higher temperatures), ambient (e.g., food item may be enjoyed at room temperature), cold (e.g., food item is preferably served at lower temperatures), and frozen (e.g., food item is preferably served while still frozen). In some embodiments, the batcher 305 is configured to prioritize orders with hot, cold, or frozen items for an earlier sequence of a batch. For example, the batcher 305 may sequence at the end of a permutation 312 those orders that include only ambient food items (or orders that are majority ambient food items). As another example, the batcher 305 may preferentially sequence orders including only frozen items, only hot items, and/or the like to an initial portion of a permutation 312.

In some embodiments, the batcher 305 is configured to receive timing estimates 310 from the timing estimator 303. For example, the batcher 305 may receive a distance matrix from the timing estimator 303. In some embodiments, the batcher 305 comprises various data based upon which metrics for a respective permutation 312 may be generated. For example, the batcher 305 may include deliverer data 314, releasable orders 316, released batches 318, and/or the like. Additionally, or alternatively, in some embodiments the batcher 305 receives deliverer data 314 from the ordering system 301, one or more QSR computing devices 309, one or more delivery person computing devices, and/or the like. The deliverer data 314 may include data indicative of delivery person efficiency and/or capacity to complete order deliveries. In some embodiments, the deliverer data 314 includes a quantity of drivers associated with the QSR and available to complete deliveries. In some embodiments, as shown in FIG. 5, a computing device of a delivery person includes a GUI by which the delivery person may indicate their availability to provide delivery services to a QSR. For example, the batching system 300 may receive from the computing device a user input selecting a particular QSR. Based on the user input, the batching system 300 may update deliverer data 314 to associate and indicate an active status of the delivery person with the selected QSR.

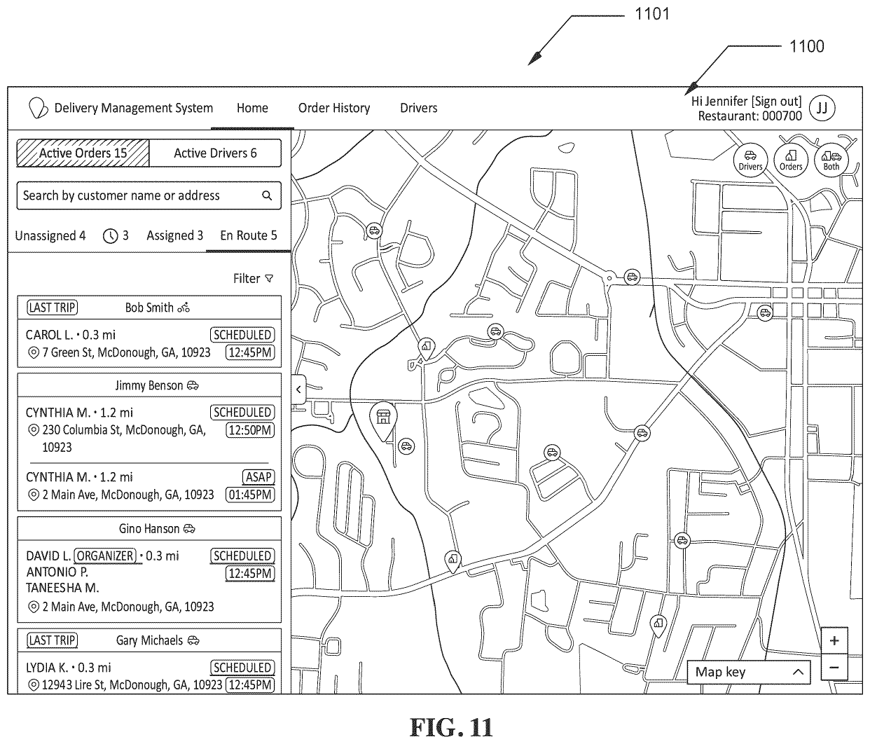

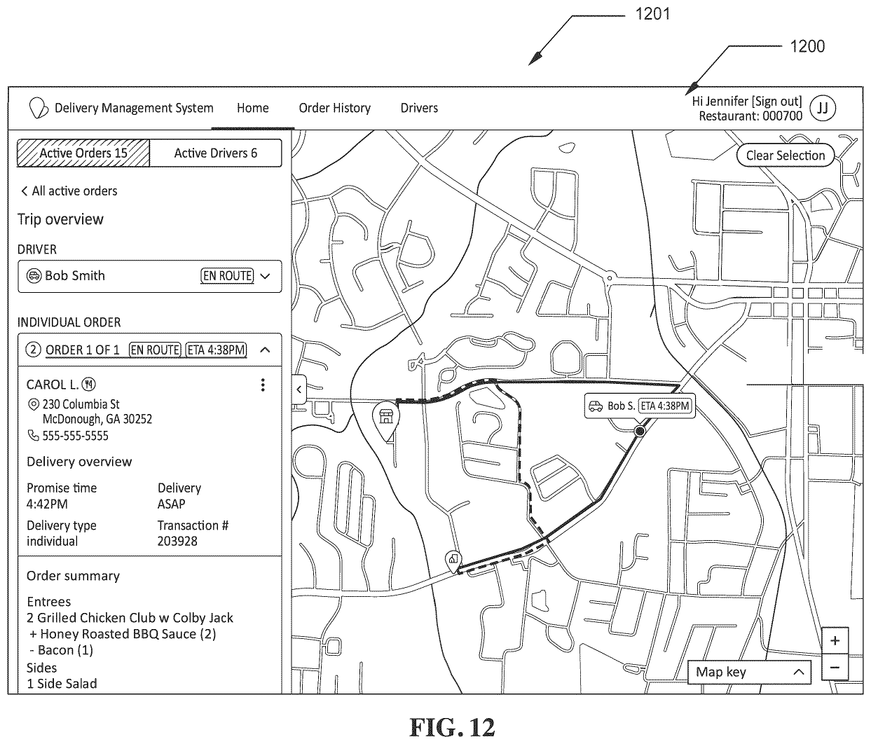

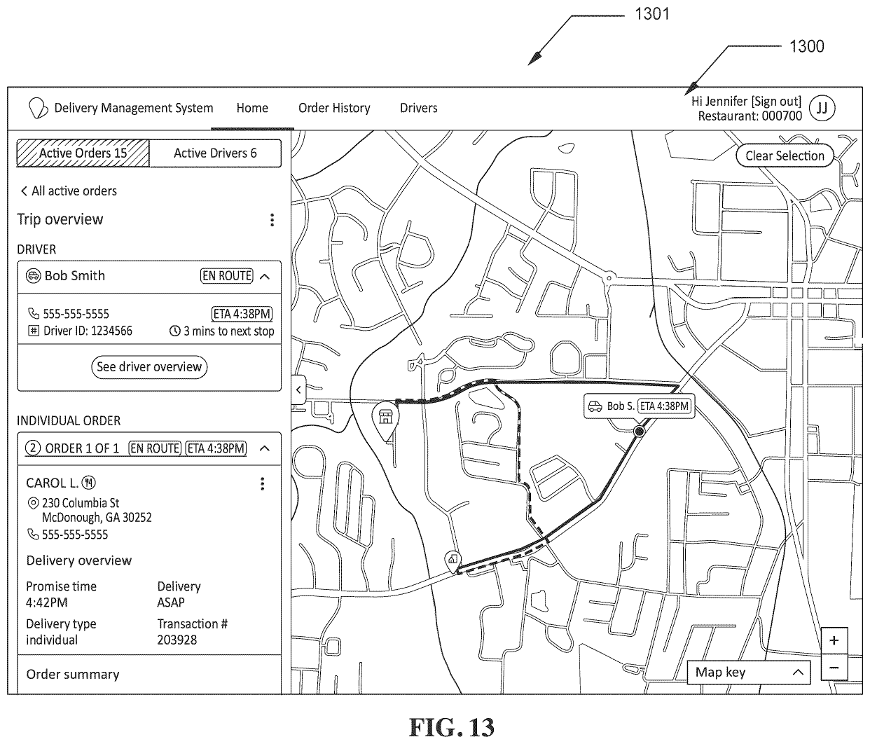

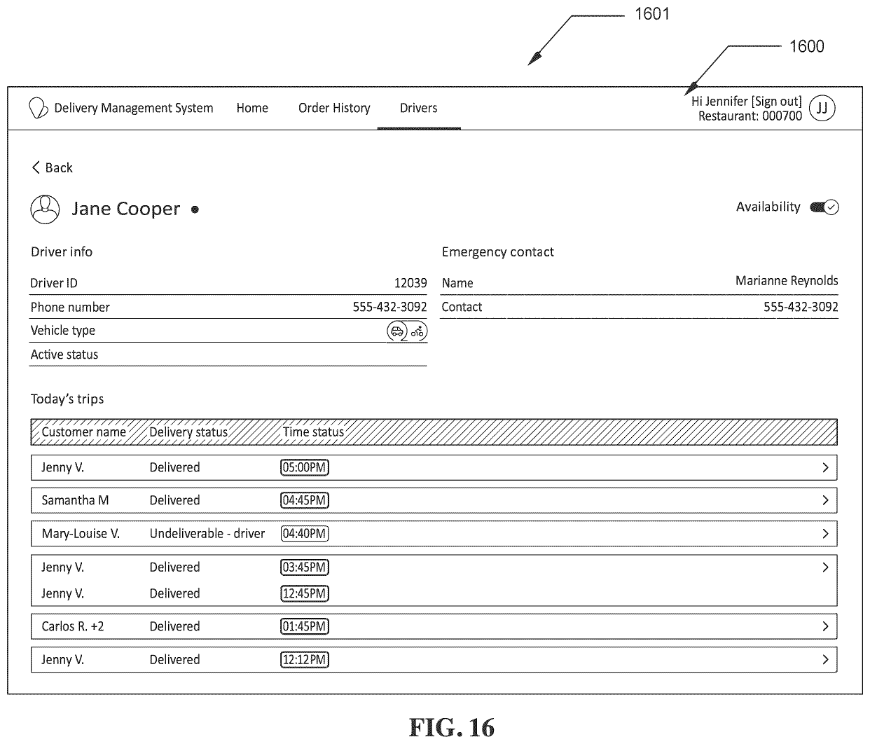

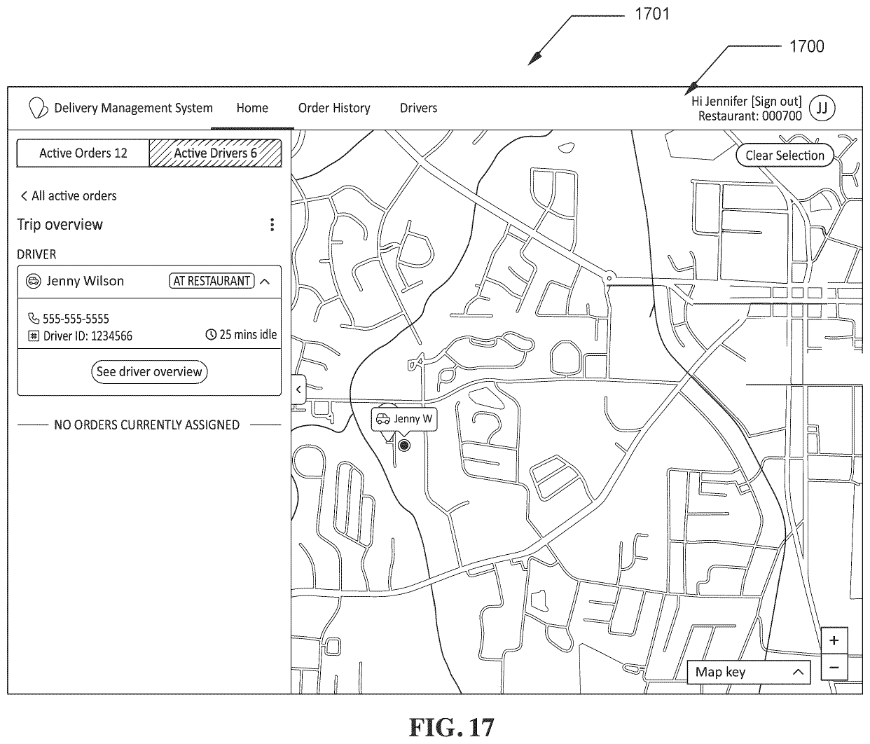

In some embodiments, the deliverer data 314 includes a current location of each delivery person. In some embodiments, the deliverer data 314 includes associations between respective drivers and orders 304 such that the batcher 305 may determine current delivery person workloads. In some embodiments, the deliverer data 314 includes a delivery person profile. For example, the deliverer data 314 may include a mode of transportation utilized by the delivery person, historical delivery times associated with the delivery person, historical delivery metrics associated with the delivery person, and/or the like. A historical delivery metric may include an average time utilized by a delivery person to pick up, load, and depart with orders from the QSR. Additionally, or alternatively, a historical delivery metric may include historical timeliness, efficiency, and/or the like of a delivery person in completing order deliveries. For example, a historical delivery metric may indicate an average time savings, average excess time, and/or the like demonstrated by the delivery person. In some embodiments, as shown in FIGS. 11-13, 16, and 17, a computing device may include one or more GUIs comprising deliverer data 314 including availability of the delivery person (FIGS. 16-17), current location of the delivery person (FIGS. 12-13), and current workload of the delivery person (FIG. 16). The deliverer data 314 may further include the name of the delivery person, contact information, transportation type, delivery history, historical delivery metrics, and/or the like.

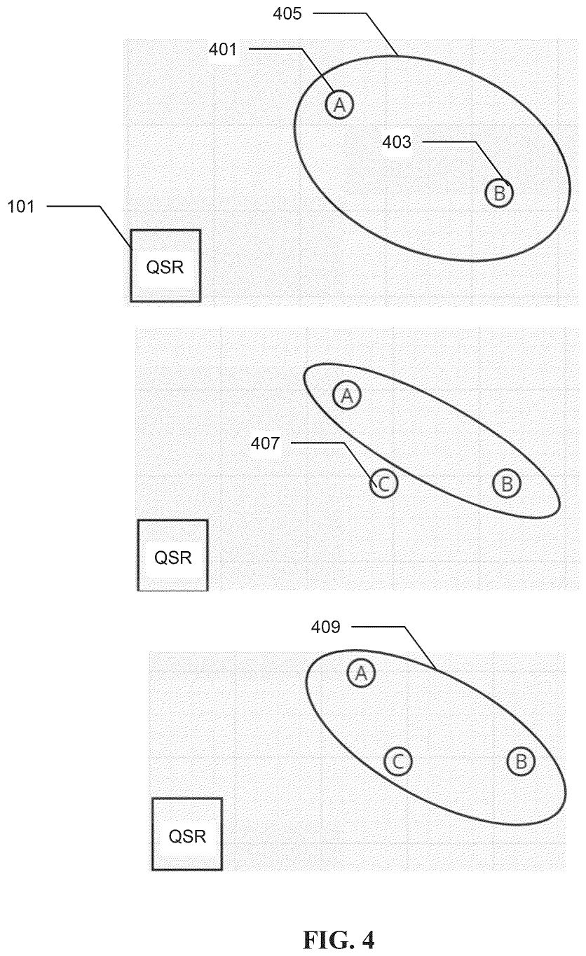

In some embodiments, the releasable orders 316 include submitted orders that have not yet been assigned to a batch and released to the kitchen of the QSR for preparation. In some embodiments, the released batches 318 include batches of orders (e.g., respective top-ranked permutations 330 from each iteration of batch generation) that have already been released to the kitchen of the QSR and will be delivered by the same delivery person. In some embodiments, the batcher 305 processes released batches 318 as an input to generating permutations 312. In doing so batcher 305 may identify instances in which a newly submitted order may be added to an existing batch that has already been released and which has not been assigned to a delivery person (see also FIG. 4 and accompanying description herein).

In some embodiments, for a respective permutation 312, the batcher 305 is configured to generate a total delivery time 320, total promise time miss 322, and total hold time miss 324 based at least in part on the timing estimate 310, deliverer data 314, and orders comprising the permutation 312. In some embodiments, the batcher 305 is configured to estimate an amount of time required to complete each leg of a permutation 312 including additional metrics for completing delivery at a destination (e.g., parking, handing off of an order, placing of an order at a drop-site, and/or the like), where the total delivery time 320, total promise time miss 322, total hold time miss 324, and/or the like may be based at least in part on the additional time metrics. In some embodiments, the total delivery time 320 estimates a total time required to complete pickup and delivery of all orders in a permutation 312 to their respective destinations. In some embodiments, the total delivery time 320 excludes an interval required for a delivery person to return to the QSR following completion of all orders in a permutation 312. In some embodiments, the total delivery time 320 includes one or more dynamic restaurant metrics representative of additional time required to package an order 304, load an order 304 into a carrier (e.g., basket, vehicle, and/or the like), and drop off an order 304 at its destination. The batcher 305 may generate the restaurant metrics based at least in part on historical deliverer data 314, historical timing estimates 310, and/or the like.

In some embodiments, the total promise time miss 322 estimates a cumulative amount of time by which the promise time of each order 304 in a permutation 312 is expected to be exceeded. The batcher 305 may generate a promise time miss for each order of a permutation 312 and generate the total promise time miss 322 based at least in part on the individualized promise time misses. For example, orders a, b, c, and d may include promise times of 2:04, 2:03, 1:59, and 2:21, respectively. A permutation 312 of [c, b, a] may include timing estimates of 3 minutes QSR to c, 3 minutes c to b, and 2 minutes b to a, where an estimated departure time for the delivery person is 1:57. In such contexts, the batcher 305 may generate, for the permutation [c, b, a], a total promise time miss 322 of 3 minutes based on an estimated 1 minute of promise time miss for QSR to c and estimated 2 minutes of promise time miss for b to a. In some embodiments, the total hold time miss 324 estimates a cumulative amount of time by which the hold time of each order is expected to be exceeded. The batcher 305 may generate a hold time miss for each order of a permutation 312 and generate the total hold time miss 324 based at least in part on the individualized hold time misses. For example, in the permutation [c, b, a], the batcher 305 may estimate a hold time miss of 0 minutes for c, 1 minute for b, and 1 minutes for b. In such contexts, the batcher 305 may generate a total promise time miss 324 of 2 minutes.

In various embodiments, the batcher 305 is configured to generate respective batch scores 328 for the permutations 312 based on the corresponding total delivery time 320, total promise time miss 322, and total hold time miss 324. In some embodiments, the batcher 305 establishes the total delivery time 320 as a base value and sums any additional time from any non-zero values of estimated promise time miss 322 and total hold time miss 324. In this manner, a batch score 328 may embody a sum of the total delivery time 320, total promise time miss 322, and total hold time miss 324.

In some embodiments, the batcher 305 is configured to apply a respective weight value 326 to one or more of the total delivery time 320, total promise time miss 322, and total hold time miss 324. In some embodiments, the weight value 326 is a coefficient by which the corresponding metric may be multiplied. The weighted metrics may be summed to generate a total batch score 328. In this manner, the weight value 326 may control a level of contribution of the corresponding metric to the batch score 328. For example, the batcher 305 may apply a first, second, and third weight value 326 to the total delivery time 320, total promise time miss 322, and total hold time miss 324, respectively. The second weight value 326 may be greater than the first weight value 326 and the third weight value 326 may be less than the first weight value 326. In applying the first, second, and third weight values 326 to the corresponding metrics, the batcher 305 may cause the total promise time miss 322 to demonstrate the greatest level of contribution and the total hold time miss 324 to demonstrate the lowest level of contribution to the batch score 328.

In some embodiments, the batcher 305 may apply weight values to component elements of total delivery time 320, total promise time miss 322, or total hold time miss 324. For example, the batcher 305 may apply one or more weight values to one or more order-individualized promise time misses based upon which the total promise time miss 322 is generated. In some embodiments, the batcher 305 applies a greater weight value to promise time misses associated with scheduled delivery orders as compared to orders placed with an “as soon as possible” delivery option. As another example, the batcher 305 may apply a greater weight value to hold time misses for orders including frozen items (e.g., milkshakes, ice cream, and/or the like) as compared to orders that lack frozen items.

In various embodiments, the ranker 307 generates a ranking of all or a subset of permutations 312 of the orders 304 based on the associated batch scores 328 and number of orders within the permutation. For example, the output ranking may be ordered by descending number of orders in the permutation and, further, by ascending batch score. In some embodiments, the batcher 305 generates sets of batch scores 328 for all permutations 312 respective to each delivery person of the QSR. In doing so, the batcher 305 may generate batch scores 328 for the same sequence of orders while accounting for simulated differences in delivery outcomes based on the delivery persons' different locations and delivery efficiencies. In such contexts, the ranker 307 may generate a ranking including all permutations 312 of all delivery persons.

In some embodiments, the ranker 307 determines a top-ranked permutation 330 based at least in part on the ranking. For example, the ranker 307 may determine a permutation 312 having the lowest batch score 328 and greatest quantity of orders. In some embodiments, the ranker 307 is configured to prioritize permutations 312 within which orders having hot, cold, or frozen items are sequenced earlier as compared to orders having ambient temperature items or fewer hot, cold, or frozen items. For example, in instances where two or more permutations 312 are tied in terms of batch score 328 and contain the same orders, the ranker 307 may prioritize a permutation 312 in which orders having only ambient temperature food items are sequenced at the end of the permutation (e.g., distributed later in fulfillment of the batch delivery). In doing so, the ranker 307 may resolve instances of equal or similar batch score by preferentially selecting permutations 312 more likely to result in customers receiving their food items within expected temperature conditions.

In various embodiments, the batching system 300 initiates preparation of orders in one or more permutations. For example, the batching system 300 may provision the orders of a permutation to a QSR kitchen, causing the QSR kitchen to begin preparing and containerizing food items. In some embodiments, the batching system 300 provisions to one or more QSR computing devices 309 an instruction to initiate preparation of one or more orders associated with the top-ranked permutation. For example, the batching system 300 may determine a time at which one or more orders may be released to a kitchen to ensure the accuracy of delivery metrics associated with the top-ranked permutation 330. The batching system 300 may provision the top-ranked permutation 330 and the determined release time to a computing device associated with the managing the kitchen. In such contexts, as shown in FIGS. 11, 14, 15, and 18, a computing device may include one or more GUIs comprising tracked delivery statuses, deliverer locations, order destinations and/or the like.

In some embodiments, the batching system 300 strategically times the release of orders to the QSR kitchen in response to determining that an estimated arrival interval of a delivery person to the QSR pickup location is within an estimated preparation interval for the orders. For example, the batching system 300 may generate an estimated preparation time for all items in a permutation based on historical preparation data for each food item type, current kitchen workload, and staffing levels. The batching system 300 may generate the estimated arrival interval of the delivery person through various means, including GPS location data from the delivery person's mobile device, real-time traffic data affecting the delivery person's return route, and historical travel time patterns for the specific delivery person. By continuously monitoring both the kitchen preparation status and delivery person location, the batching system 300 may optimize order release timing to ensure food items reach optimal quality precisely when the delivery person arrives for pickup, thereby maximizing both food freshness and delivery efficiency. In some embodiments, the batching system 300 may dynamically adjust order release timing in response to unexpected delays in either preparation or delivery person arrival, such as by expediting or delaying certain food items to maintain synchronization between completion and pickup times.

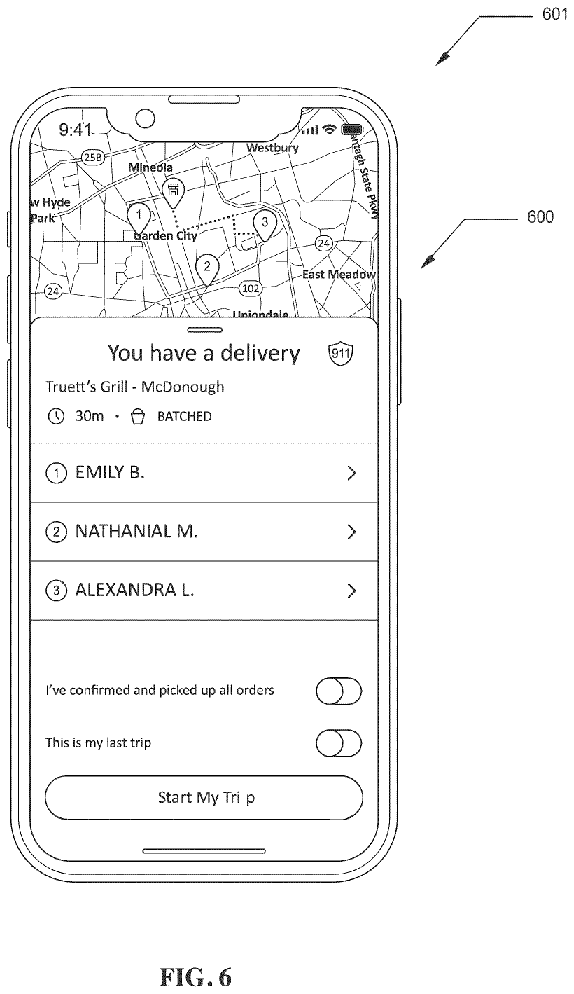

In various embodiments, the batching system 300 dispatches delivery of the orders in a top-ranked permutation to the assigned delivery person. For example, the ranker 307 may provision a top-ranked permutation 330 to a computing device of a delivery person (see FIGS. 6-9). In some embodiments, the batching system 300 provisions a sequence of batched orders comprising the top-ranked permutation 330 to a smartphone carried by a delivery person assigned to complete delivery of the orders. In some embodiments, the top-ranked permutation 330 indicates a particular delivery person for completing the batch of orders being represented. Alternatively, in some embodiments, the QSR computing device 309 (or an element of the batching system 300, such as the ordering system 301) determines a delivery person to assign to the top-ranked permutation 330 and causes subsequent provision of the batch details to the computing device of the delivery person.

In some embodiments, the batching system 300 dispatches delivery information through external systems or third-party services that interface with delivery personnel. For example, the batching system 300 may transmit the top-ranked permutation 330, delivery instructions, route optimization data, and order details to a fleet management platform, logistics coordination service, or delivery management application that subsequently forwards the information to the computing device of the assigned delivery person. In some cases, the batching system 300 may integrate with external communication systems, such as SMS gateways, push notification services, or messaging platforms, to ensure delivery personnel receive batch assignments and routing instructions through their preferred communication channels or existing workflow management tools.

In some embodiments, the batching system 300 generates an estimated interval for preparing one or more orders. For example, the ordering system 301 may estimate an amount of time required to prepare all items of an order. In some embodiments, the batching system 300 generates an estimated interval for a delivery person to arrive at the QSR. For example, following assignment of a delivery person to a batch, the ordering system 301, timing estimator 303, batcher 305, and/or the like may estimate an amount of time required for the delivery person to return from delivering a previously released batch. In various embodiments, the batching system 300 releases a batch (e.g., top-ranked permutation 330) to the QSR kitchen in response to determining that the estimated preparation interval and the estimated arrival interval are within a threshold range or equal. For example, in response to determining that an estimated time for preparing a batch of orders equals an estimated time for the assigned delivery person to return to the QSR, the batching system 300 may provision the batched orders to the QSR computing device 309. In doing so, the batching system 300 may improve efficiency and preserve food quality by ensuring that orders are ready for pickup and loading as soon as the assigned delivery person arrives to the QSR.

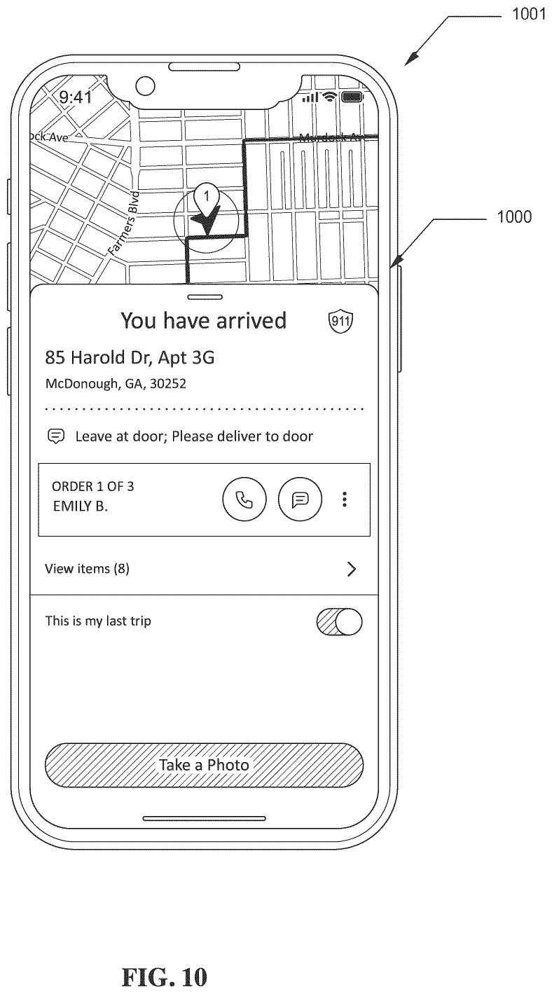

In some embodiments, the batching system 300 monitors fulfillment of batches and generates historical delivery data based upon which subsequent batching processes may be optimized and improved. For example, the batching system 300 may obtain values of actual delivery time, actual promise time miss, and actual hold time miss. In some contexts, as shown in FIG. 10, a computing device may receive a user input indicating completion of an order. In response to receiving the user input, the computing device may provision to the batching system 300 an indication of completion for the associated order and batch. The batching system 300 may compare the actual times to the estimated times generated by the batcher 305 and adjust one or more settings, parameters, settings, and/or the like of the batcher toward reducing a delta between the respective values.

FIG. 4 shows an example diagram of an order batching approach in accordance with some embodiments of the present disclosure. In some embodiments, following generation of a batch 405 comprising a first order 401 and a second order 403, the QSR 101 receives one or more additional orders. For example, following generation of an optimal permutation (e.g., batch 405) by the batcher 305 and ranker 307, the ordering system 301 may receive an additional order 407 prior to pick up of the batched orders from the QSR 101. The batching system 300 may perform a batching process based on the order 407, any additional releasable orders, and released batches, including the batch 405. The batching system 300 may generate a new permutation comprising all three orders 401, 403, and 407, where the batched orders may be delivered by the same delivery person while satisfying their respective hold times and promises times. The batching system 300 may generate a batch score for the new permutation and determine that the new permutation is now the most optimal (e.g., due to including the most orders). Additionally, or alternatively, the batching system 300 may determine whether a destination of the additional order is within a threshold range (e.g., distance, travel time, and/or the like) of the respective destinations of the first order 401 and second order 403. The batching system 300 may update the batch 405 to comprise the additional order in response to determining that the destination of the additional order is within the threshold range to one or more of the first order 401, second order 403, and additional order 407. Alternatively, the batching system 300 may generate a new batch 409, deleting the batch 405 from the system, the computing device of the delivery person, and/or the like. Whereas typical approaches to batching may assign additional order 407 to a new delivery person or require delay of delivering the order 407 until return of the previously tasked delivery person, the batching system 300 may cause assignment of all three orders 401, 403, and 407 to the same delivery person. In doing so, the batching system 300 may improve restaurant and delivery person efficiency as compared to other approaches.

FIG. 5 shows a computing device 501 having rendered thereon a delivery availability interface 500. For example, the interface 500 may present a list of available QSR locations with corresponding distance information and availability status indicators. In some embodiments, the interface 500 includes location names, addresses, and proximity measurements to assist delivery persons in selecting appropriate service areas. For example, the interface 500 may display “Truett's Grill—McDonough [12536]” at a distance of 5.3 miles, along with other location options. In various embodiments, the interface 500 includes an “I Am Available” input field that allows delivery persons to indicate their readiness to accept delivery assignments. In some embodiments, the interface 500 provides visual indicators such as “(Get closer)” notifications to guide delivery persons toward optimal positioning relative to QSR locations. In some embodiments, in response to a delivery person indicating a change in their mode of transportation through the interface, such as switching from a car to a scooter, the batching system 300 updates one or more delivery metrics, such as timing estimates 310, and adjusts batch permutations 312 or delivery person assignments to account for the modified travel speed capabilities, potentially reducing batch sizes or adjusting delivery routes to maintain promise time compliance.

FIG. 6 illustrates a computing device 601 having rendered thereon a batched delivery assignment interface 600. For example, the interface 600 may combine a map view with delivery order information, showing locations such as Westbury, Mineola, Garden City, and East Meadow. In some embodiments, the interface 600 displays a delivery notification panel indicating “You have a delivery” from a specific QSR location with timing information and batch status. For example, the interface 600 may show a “30 m” time indicator and “BATCHED” status designation. In various embodiments, the interface 600 presents a list of customer names for batched orders, including “EMILY B.,” “NATHANIAL M.,” and “ALEXANDRA L.” In some embodiments, the interface 600 includes toggle switches for “I've confirmed and picked up all orders” and “This is my last trip,” along with a “Start My Trip” input field to initiate delivery execution. In some embodiments, in response to a delivery person activating the “This is my last trip” toggle, the batching system 300 modifies batching processes to account for changes in workforce availability, adjusting the deliverer data 314 to reflect the imminent reduction in delivery capacity, and potentially prioritizing orders with approaching promise times or hold times for the remaining delivery persons.

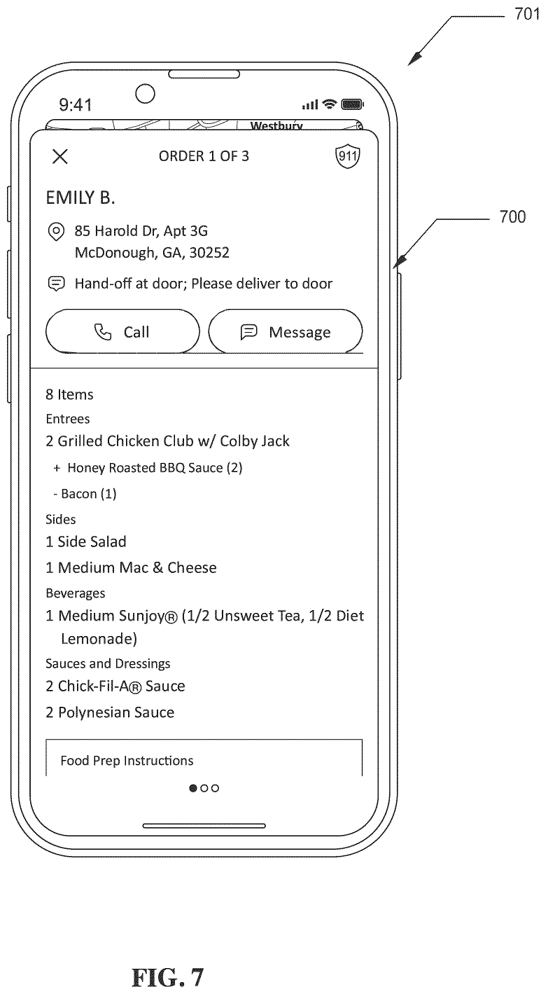

FIG. 7 depicts a computing device 701 having rendered thereon an order information interface 700, which may be associated with the first order in a three-order batch. For example, the interface 700 may display “ORDER 1 OF 3” along with customer delivery address and specific delivery instructions requesting hand-off at the door. In some embodiments, the interface 700 includes “Call” and “Message” input fields for customer communication. For example, the order details section may organize items into categories including Entrees, Sides, Beverages, and Sauces and Dressings. In various embodiments, the interface 700 presents specific food items such as “2 Grilled Chicken Club with Colby Jack,” “1 Side Salad,” “1 Medium Mac & Cheese,” and “1 Medium Sunjoy® (½ Unsweet Tea, ½ Diet Lemonade).” In some embodiments, the interface 700 includes a “Food Prep Instructions” section with pagination indicators for additional content.

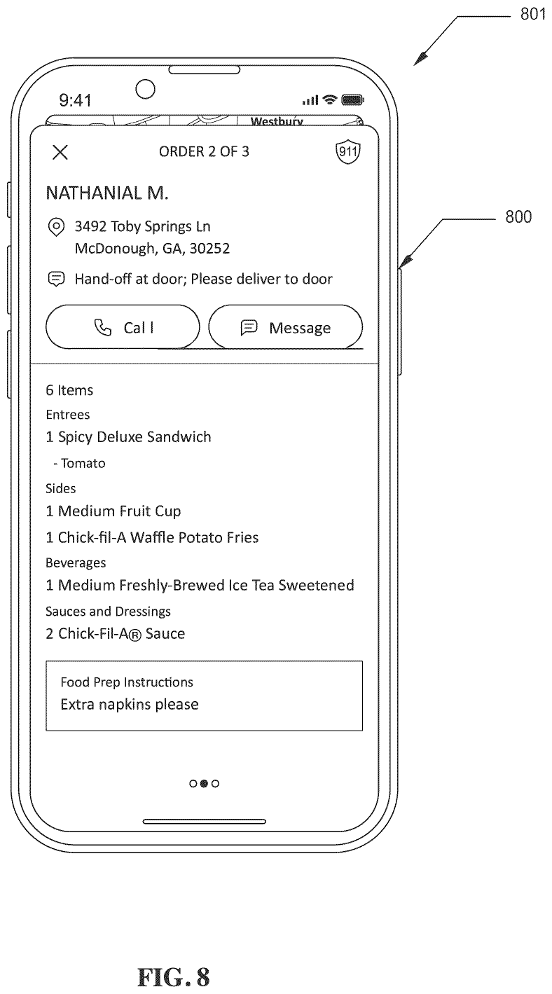

FIG. 8 shows a computing device 801 having rendered thereon an order information interface 800, which may be associated with the second order in a three-order sequence. For example, the interface 800 may indicate “ORDER 2 OF 3” with customer delivery information including address at 3492 Toby Springs Ln in McDonough, GA. In some embodiments, the interface 800 specifies delivery instructions as “Hand-off at door; Please deliver to door” and provides customer contact options. For example, the order may comprise items categorized as Entrees, Sides, Beverages, and Sauces and Dressings, including “1 Spicy Deluxe Sandwich (with tomato),” “1 Medium Fruit Cup,” “1 Chick-fil-A Waffle Potato Fries,” and “1 Medium Freshly-Brewed Ice Tea Sweetened.” In various embodiments, the interface 800 includes order preparation instructions noting “Extra napkins please.” In some embodiments, the computing device may dynamically update the displayed interface as the delivery person progresses through the determined permutation sequence. For example, upon confirmation of delivery for the first order through interface 700, the computing device may automatically transition to display interface 800 for the second order in the batch, and subsequently to interface 900 for the third order, thereby providing sequential order information that corresponds to the optimized delivery route established by the top-ranked permutation 330.

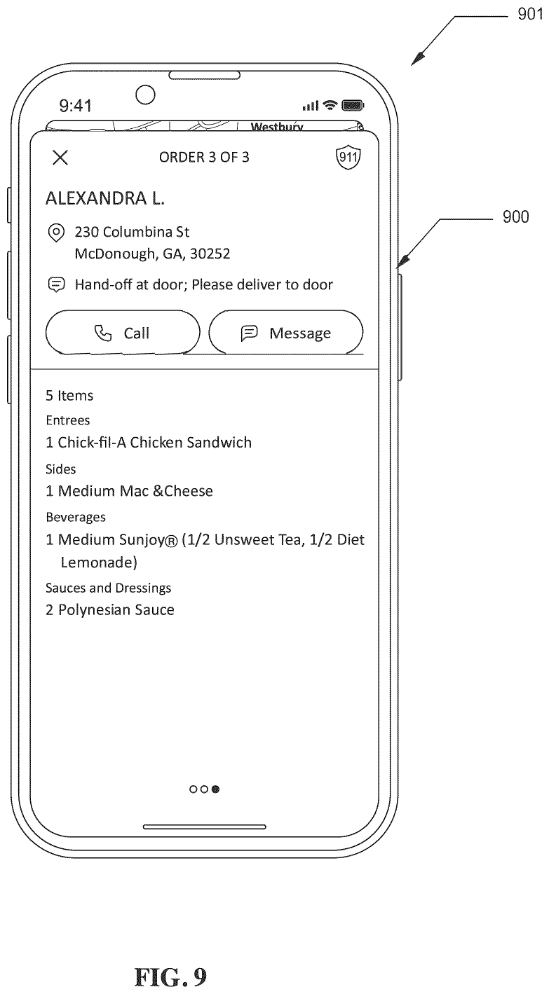

FIG. 9 illustrates a computing device 901 having rendered thereon an order information interface 900, which may be associated with the final order in a three-order batch. For example, the interface 900 may display “ORDER 3 OF 3” with delivery details for a customer at 230 Columbia St in McDonough, GA. In some embodiments, the interface 900 maintains consistent formatting with previous orders, including delivery instructions and customer contact options. For example, the order may contain items such as “1 Chick-fil-A Chicken Sandwich,” “1 Medium Mac & Cheese,” “1 Medium Sunjoy® (½ Unsweet Tea, ½ Diet Lemonade),” and “2 Polynesian Sauce.” In various embodiments, the interface 900 includes selectable fields enabling the delivery person to indicate a status of their order containment devices, such as integrity of paper bags, issues with active or passive insulation systems, and/or the like. In some embodiments, in response to a delivery person reporting through the interface that the active insulation system of their vehicle requires servicing, such as charging or replacement of cooling or heating elements, the batching system 300 adjusts the hold time calculations for temperature-sensitive items, potentially prioritizing delivery of frozen or hot items before ambient items, and may initiate a workflow to assign a replacement delivery person with functioning equipment for subsequent temperature-sensitive orders.

FIG. 10 shows a computing device 1001 having rendered thereon a delivery confirmation interface 1000. In some embodiments, the interface 1000 is rendered on the display in response to a delivery person moving within a predetermined range of an order destination. For example, the interface 1000 may include a map view with location indicators and may display “You have arrived” along with the specific delivery address “85 Harold Dr, Apt 3G” in McDonough, GA. In some embodiments, the interface 1000 presents delivery instructions stating “Leave at door; Please deliver to door” and indicates the order position as “ORDER 1 OF 3.” For example, the interface 1000 may include circular input fields for calls and messages, along with a “View items (8)” option.

In various embodiments, the interface 1000 provides a toggle switch labeled “This is my last trip.” In some embodiments, the interface 1000 includes a “Take a Photo” input for delivery confirmation documentation. In some embodiments, in response to a delivery person indicating through the interface that an order is undeliverable, the batching system 300 initiates an exception workflow, updating the order status in the system, notifying the customer through available communication channels, and providing the delivery person with instructions for returning the order to the QSR or disposing of perishable items as appropriate. In various embodiments, the batching system 300 regenerates and/or updates the delivery route for remaining orders in the batch to optimize the adjusted delivery sequence and minimize impact to other customers' promise times.

FIG. 11 depicts a computing device 1101 having rendered thereon a delivery management network interface 1100 with route visualization. For example, the interface 1100 may present a map-like layout displaying interconnected paths and delivery zones. In some embodiments, the interface 1100 shows multiple branching paths and intersections representing different delivery areas and route options. For example, the network structure may include curved and straight pathways that intersect at various points, creating a complex system of possible delivery routes. In various embodiments, the interface 1100 includes distance markers and route indicators for determining delivery times and optimizing route selections. In some embodiments, in response to a delivery person indicating a change in transportation mode through the interface, the batching system 300 regenerates or updates all possible route permutations based on the new transportation characteristics, potentially identifying more efficient pathways for bicycles or scooters that are not available to automobiles, or adjusting for reduced speed capabilities when switching from motorized to non-motorized transportation.

FIG. 12 illustrates a computing device 1201 having rendered thereon a comprehensive delivery management interface 1200 combining map functionality with operational controls. For example, the interface 1200 may display a detailed street layout with various intersections, residential areas, and routing paths. In some embodiments, the interface 1200 includes navigation controls such as zoom and directional controls in the upper right corner. For example, the bottom section may contain delivery management controls and information panels, including order details, delivery status updates, and driver information. In various embodiments, the interface 1200 facilitates efficient delivery route planning and real-time order tracking within the mapped delivery area. In some embodiments, in response to a delivery person indicating through the interface that they require refueling their vehicle, the batching system 300 analyzes the current location relative to nearby fueling stations and the remaining delivery destinations, calculating optimal refueling stops that minimize deviation from the planned route while ensuring sufficient fuel for completing all deliveries. In various embodiments, the batching system 300 also adjusts promise time expectations for affected customers and provides notifications regarding potential slight delays.

FIG. 13 shows a computing device 1301 having rendered thereon an integrated delivery management system interface 1300 with map visualization and operational panels. For example, the interface 1300 may present a network of streets and pathways with various route segments and intersections clearly visible. In some embodiments, the interface 1300 includes navigation controls for map manipulation, such as zooming and panning functions. For example, the delivery management panel may contain sections for trip overview, active drivers, and delivery status information. In various embodiments, the interface 1300 enables efficient monitoring and management of delivery operations through the combination of geographical visualization and operational data. In some embodiments, in response to a delivery person reporting through the interface that an order has experienced a quality issue requiring replacement, the batching system 300 identifies the optimal return route to the QSR, initiates preparation of replacement items, and updates the delivery sequence for any remaining orders in the batch, potentially reassigning them to other available delivery persons to maintain promise time compliance while the affected delivery person returns for the replacement order.

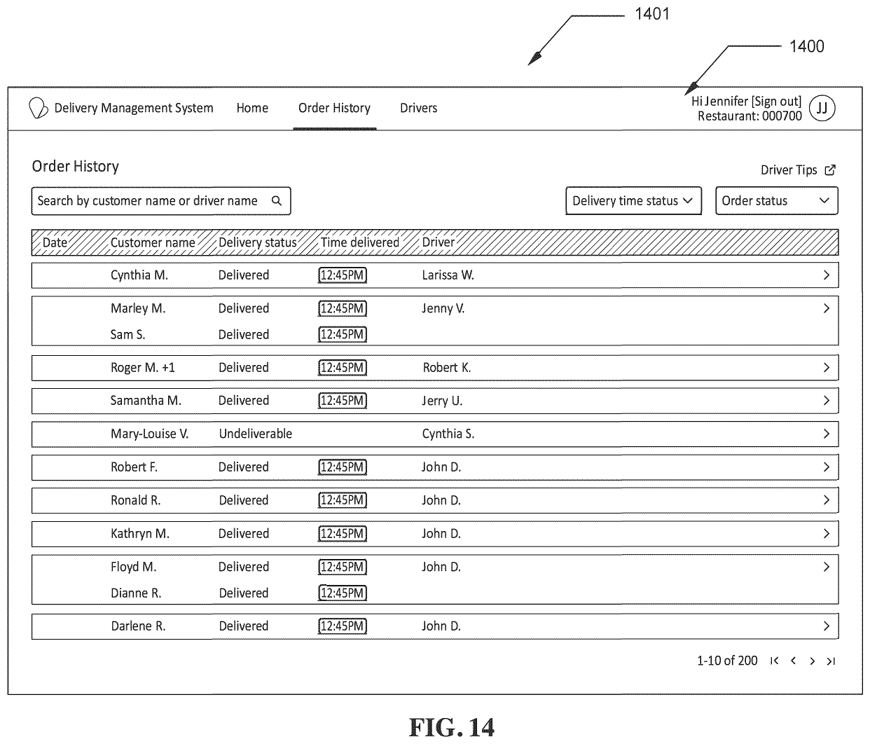

FIG. 14 depicts a computing device 1401 having rendered thereon an order history interface 1400 for tracking completed deliveries. For example, the interface 1400 may display multiple delivered orders in a tabular format with each row showing delivery status information marked as “Delivered” along with corresponding timestamps. In some embodiments, the interface 1400 presents order information in columns including system name, order history details, and delivery status. For example, the interface 1400 may include navigation controls at the top for interacting with and filtering the order history data. In various embodiments, the batching system 300 provides a clear visual organization of delivery data, with respective rows representing a distinct order transaction and its associated delivery status.

In some embodiments, in response to a delivery person indicating through the interface that an order was undeliverable, the batching system 300 updates the order status in the system, determining and storing one or more factors for undeliverability. The batching system 300 may reduce a prioritization weight value associated with the order destination or customer for future batching calculations to account for delivery challenges at that location. In some embodiments, factors for undeliverability include incorrect or incomplete delivery addresses, customer unavailability at the delivery location, access restrictions such as gated communities or secured buildings, adverse weather conditions preventing safe delivery, vehicle breakdown or mechanical issues, traffic incidents or road closures blocking access to the destination, customer requests to cancel or reschedule the delivery upon arrival, customer refusal of order, and/or the like. In some embodiments, in response to an order being undeliverable, the batching system 300 adjusts a prioritization weight value associated with the order destination or customer for future batching processes to account for delivery challenges at that location.

In some embodiments, the batching system 300 may increase a prioritization weight value for destinations that demonstrate consistent successful deliveries, such as residential addresses with clear access routes, reliable customer availability, and accurate address information. In various embodiments, the batching system 300 may also increase prioritization weights for destinations associated with customers who provide detailed delivery instructions, maintain consistent availability during promised delivery windows, or demonstrate positive delivery history patterns. In some embodiments, the batching system 300 may decrease prioritization weight values for destinations that present recurring delivery challenges. For example, the batching system 300 may reduce prioritization for destinations associated with customers who are frequently unavailable during delivery windows, provide incorrect or incomplete address information, or have a history of order cancellations upon delivery arrival. In some cases, the batching system 300 may apply reduced prioritization to destinations in areas with recurring adverse weather impacts, such as locations prone to flooding or areas with steep terrain that may be inaccessible during certain weather conditions.

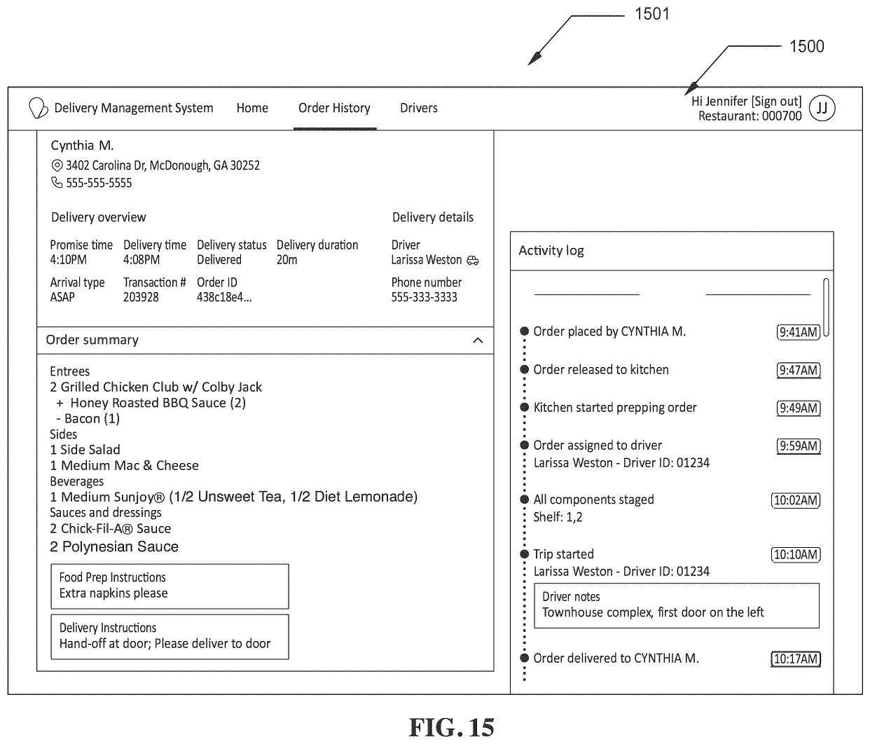

FIG. 15 illustrates a computing device 1501 having rendered thereon an activity log interface 1500 displaying the chronological sequence of events for order processing and delivery management. For example, the interface 1500 may show a detailed timeline of activities with multiple timestamped events arranged vertically, connected by a vertical line to show progression. In some embodiments, the sequence includes events such as “Order placed by CYNTHIA M.,” “Order released to kitchen,” “Kitchen started preparing order,” “Order assigned to driver,” and “Order delivered to CYNTHIA M.” The interface 1500 may include delivery details, such as delivery time, arrival type, order summary, and delivery instructions. In various embodiments, respective events in the timeline are accompanied by a timestamp to track when specific actions occurred. In some embodiments, in response to a delivery person indicating through the interface that the active insulation system of their vehicle requires servicing, the batching system 300 logs the event in the activity timeline, initiates appropriate service requests, and adjusts delivery assignments to utilize delivery persons with functioning equipment for temperature-sensitive orders until the affected vehicle's systems are restored to operational status.

FIG. 16 shows a computing device 1601 having rendered thereon a delivery management system interface 1600 with driver information and delivery status tracking. For example, the interface 1600 may include a back navigation option and may show availability status indicators. In some embodiments, the driver info section displays contact details including a phone number. For example, the interface 1600 may present delivery status information in a series of rows with different status indicators such as “Delivered” and “Undeliverable—other” shown for various deliveries. In various embodiments, the batching system 300 tracks multiple deliveries simultaneously, with respective rows representing separate delivery statuses. In some embodiments, the batching system 300 is configured to track and maintain driver availability statuses. In various embodiments, the batching system 300 may dynamically adapt batching processes in response to delivery persons becoming available or unavailable, updating permutations and potentially reassigning orders to optimize delivery efficiency based on the updated workforce capacity.

FIG. 17 illustrates a computing device 1701 having rendered thereon a delivery management system interface 1700 with map view displaying various routes and locations. For example, the interface 1700 may include a map region showing street layouts and navigation paths with road networks, intersections, and pathways forming a complex grid pattern. In some embodiments, the interface 1700 displays different zones and areas interconnected by streets and thoroughfares. For example, navigation controls may be visible in the interface 1700, including zoom functionality indicated by plus and minus symbols. In various embodiments, the batching system 300 presents a detailed street-level view supporting delivery management and route optimization functions with both main arterial roads and smaller side streets creating a comprehensive network for delivery navigation. In some embodiments, in response to a delivery person indicating through the interface that they will be making their last trip, the batching system 300 recomputes workforce distribution across the delivery network, potentially adjusting batches or zone assignments for remaining delivery persons to ensure continued coverage of all service areas.

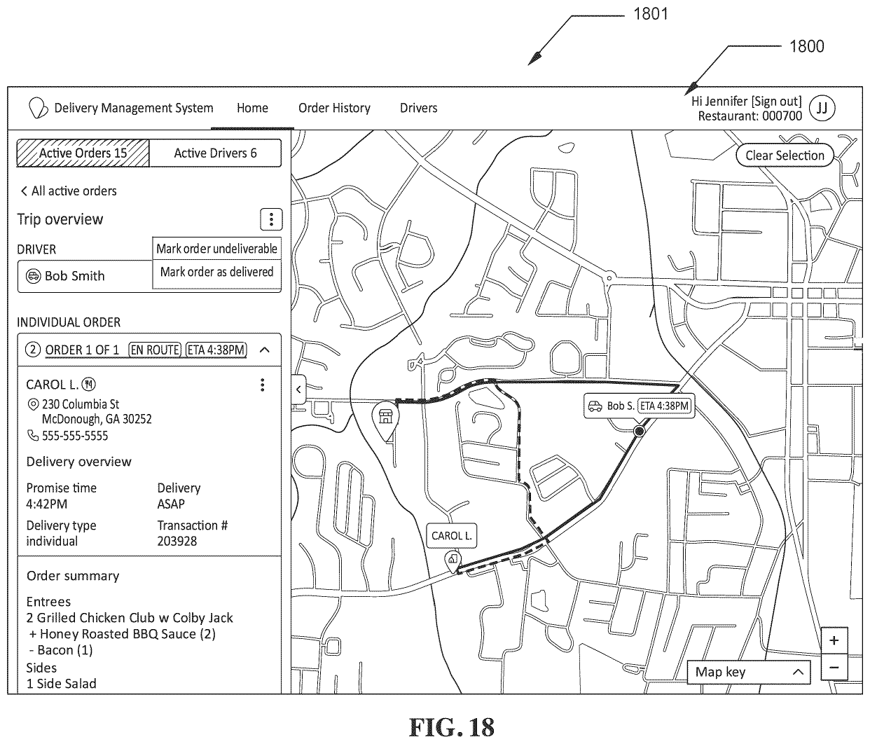

FIG. 18 depicts a computing device 1801 having rendered thereon a delivery management system interface 1800, which may integrate a map view with associated order information. For example, the interface 1800 may comprise a map region displaying various streets and routes with an active delivery area. In some embodiments, the interface 1800 presents interactive elements including zoom controls and navigation options for interacting with the map view. For example, a trip overview panel may contain delivery information and order details, including fields for delivery type, transaction identification, order summary, and delivery status indicators. In various embodiments, the interface 1800 integrates mapping capabilities with delivery management tools, enabling users to monitor and coordinate delivery operations through both geographical data and delivery-specific information in an organized format.

In some embodiments, the batching system 300 updates a delivery plan for one or more orders in response to a delivery person providing inputs through the interface 1800 that indicate an order has experienced a quality issue. For example, in response to the interface 1800 receiving user input indicating that beverages have spilled during transport or that frozen items have begun to melt prematurely, the batching system 300 may prioritize those affected orders for immediate re-release to the QSR kitchen and prioritized delivery. As another example, the batching system 300 adjust batching processes in response to receiving user input indicating that the active insulation system of a delivery person requires servicing (e.g., recharging, swapping of hot or cold elements). The batching system 300 may update hold time metrics for the associated orders based on the compromised insulation capabilities and potentially reassign temperature-sensitive orders to other delivery persons with functioning equipment to ensure food quality standards are maintained despite the equipment limitations.

In various embodiments, when generating permutations for replacement orders, the batching system 300 may apply enhanced weight values to prioritize these orders during the scoring and ranking process, potentially increasing the weight applied to total promise time miss or total hold time miss to ensure expedited fulfillment. In some embodiments, the batching system 300 may evaluate existing released batches that have not yet been picked up by their assigned delivery persons to determine whether replacement orders may be incorporated into these batches, analyzing factors such as route compatibility, delivery person capacity, and timing constraints to determine opportunities for efficient batch consolidation without compromising promise times for existing orders in the batch.

In various embodiments, when generating permutations for replacement orders, the batching system 300 may apply enhanced weight values to prioritize these orders during the scoring and ranking process, potentially increasing the weight applied to total promise time miss or total hold time miss to ensure expedited fulfillment. In some embodiments, the batching system 300 may evaluate existing released batches that have not yet been picked up by their assigned delivery persons to determine whether replacement orders may be incorporated into these batches, analyzing factors such as route compatibility, delivery person capacity, and timing constraints to determine opportunities for efficient batch consolidation without compromising promise times for existing orders in the batch. In various embodiments, the dynamic batching capabilities may provide particular advantages for QSRs that maintain their own delivery workforce with a fixed number of delivery persons. For example, the batching system 300 may optimize delivery performance and resource utilization while maintaining food quality levels despite the QSR lacking the ability to dynamically scale staffing through independent contractors or third-party delivery services.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server. In some embodiments, some of the operations above may be modified or further amplified. Furthermore, in some embodiments, additional optional operations may be included. Modifications, amplifications, or additions to the operations above may be performed in any order and in any combination.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Moreover, the separation of various system components in the embodiments described above should not be understood as requiring such separation in all embodiments, and it should be understood that the described program components and systems can generally be integrated together in a single software product or packaged into multiple software products.

While various aspects have been described, additional aspects, features, and methodologies of the claimed apparatuses will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps. In certain implementations, multitasking and parallel processing may be advantageous.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

That which is claimed is:

1. A method for delivery management, comprising:
receiving a plurality of orders for delivery to a plurality of destinations;
generating a plurality of permutations of the plurality of orders corresponding to different sequences of the plurality of destinations;
estimating, for the plurality of permutations, one or more of a total delivery time, a total promise time miss, and a total hold time miss;
generating, for the plurality of permutations, a batch score based on the one or more of the total delivery time, the total promise time miss, and the total hold time miss;
generating a ranking of at least a portion of the plurality of permutations based on the respective batch scores;
determining a top-ranked permutation based on the ranking;
assigning orders in the top-ranked permutation to one of a plurality of delivery persons for fulfillment;
initiating preparation of the orders in the top-ranked permutation in response to determining that an estimated arrival interval of the one of the plurality of delivery persons is within an estimated preparation interval for the orders in the top-ranked permutation; and
dispatching delivery of the orders in the top-ranked permutation to the one of the plurality of delivery persons.

2. The method of claim 1, further comprising:
obtaining deliverer data associated with the plurality of delivery persons; and
generating the batch score based at least in part on the deliverer data.

3. The method of claim 2, wherein the deliverer data comprises a respective current location of the plurality of delivery persons.

4. The method of claim 2, wherein the deliverer data comprises a respective transportation mode of the plurality of delivery persons.

5. The method of claim 2, wherein the deliverer data comprises, for the plurality of delivery persons, at least one historical delivery metric associated with the respective delivery person.

6. The method of claim 5, wherein the at least one historical delivery metric comprises at least one of an average order completion time, a historical timeliness metric, a historical efficiency metric.

7. The method of claim 2, wherein the deliverer data comprises a respective current workload of the plurality of delivery persons.

8. The method of claim 2, wherein the deliverer data comprises a respective availability status of the plurality of delivery persons.

9. The method of claim 2, wherein the deliverer data comprises an estimated QSR return time for the plurality of delivery persons.

10. The method of claim 2, wherein the deliverer data comprises a respective carrying capacity of the plurality of delivery persons.

11. An apparatus for delivery management, comprising:
at least one processor; and
at least one memory including computer program code for one or more programs, the at least one memory and the computer program code configured to, with the at least one processor, cause the apparatus to:
receive a plurality of orders for delivery;
generate a plurality of permutations of the plurality of orders;
estimate, for the plurality of permutations, one or more of a total delivery time, a total promise time miss, and a total hold time miss;
generate, for the plurality of permutations, a batch score based on one or more of the total delivery time, total promise time miss, and total hold time miss;
generate a ranking of at least a portion of the plurality of permutations based on the respective batch scores;
determine a top-ranked permutation based on the ranking;
assign orders in the top-ranked permutation to one of a plurality of delivery persons for fulfillment;
initiate preparation of the orders in the top-ranked permutation in response to determining that an estimated arrival interval of the one of the plurality of delivery persons is within an estimated preparation interval for the orders in the top-ranked permutation; and
dispatch delivery of the orders in the top-ranked permutation to the one of the plurality of delivery persons.

12. The apparatus of claim 11, wherein:
a respective permutation is associated with one of a plurality of delivery persons;
a respective order comprises at least one food item; and
the program code, when executed by the at least one processor, is further configured to cause the apparatus to:
determine at least one of a plurality of temperature classifications associated with the at least one food item; and/or
determine one of a plurality of container types associated with the delivery person; and
generate the total hold time miss based at least in part on the temperature classification and/or the container type.

13. The apparatus of claim 12, wherein: the plurality of container types comprise paper container, passive insulated container, or active climate-controlled delivery container.

14. The apparatus of claim 12, wherein the plurality of temperature classifications comprise hot, ambient, cold, and frozen.

15. The apparatus of claim 11, wherein:
the program code, when executed by the at least one processor, is further configured to cause the apparatus to:
generate, for the plurality of delivery persons, at least one dynamic driver metric based on real-time delivery data; and
update the batch score based on the at least one dynamic driver metric.

16. The apparatus of claim 11, wherein:
the program code, when executed by the at least one processor, is further configured to cause the apparatus to:
apply a first weight value to the total delivery time; and/or
apply a second weight value to the total promise time miss; and/or
apply a third weight value to the total hold time miss; and/or
generate the batch score based on the weighted total delivery time, the weighted total promise time miss, and/or the weighted total hold time miss.

17. The apparatus of claim 16, wherein:
the program code, when executed by the at least one processor, is further configured to cause the apparatus to:
receive, via a user interface, an adjustment to at least one of the first weight value, the second weight value, or the third weight value;
apply the adjustment to the at least one of the first weight value, the second weight value, or the third weight value; and
generate updated batch scores for subsequent permutations based on the adjusted weight values.

18. The apparatus of claim 16, wherein:
a respective order comprises at least one food item; and
the program code, when executed by the at least one processor, is further configured to cause the apparatus to:
generate the third weight value based at least in part on a temperature classification of the at least one food item of the plurality of orders.

19. The apparatus of claim 11, wherein:
the program code, when executed by the at least one processor, is further configured to cause the apparatus to:
receive an additional order after preparation of the orders in the top-ranked permutation has occurred;
in response to determining that a proximity of a destination of the additional order is within a threshold range to a destination of at least one of the orders in the top-ranked permutation, update the top-ranked permutation to comprise the additional order; and
initiate preparation of the additional order.

20. A computer program product comprising at least one non-transitory computer-readable storage medium having computer program code stored thereon that, in execution with at least one processor, is configured to:
receive a plurality of orders for delivery;
generate a plurality of permutations of the plurality of orders;
estimate, for the plurality of permutations, one or more of a total delivery time, a total promise time miss, and a total hold time miss;
generate, for the plurality of permutations, a batch score based on one or more of the total delivery time, the total promise time miss, and the total hold time miss;
generate a ranking of at least a portion of the plurality of permutations based on the respective batch scores;
determine a top-ranked permutation based on the ranking; and
assign orders in the top-ranked permutation to one of a plurality of delivery persons for fulfillment
initiate preparation of the orders in the top-ranked permutation in response to determining that an estimated arrival interval of the one of the plurality of delivery persons is within an estimated preparation interval for the orders in the top-ranked permutation; and
dispatch delivery of the orders in the top-ranked permutation to the one of the plurality of delivery persons.
